(19) United States
(12) Patent Application Publication
(10) Pub. No.: US 2010/0060523 A1
(43) Pub. Date: Mar. 11, 2010

(54) ADAPTIVE ARRAY ANTENNA APPARATUS AND ADAPTIVE CONTROL METHOD THEREFOR

(75) Inventors: Chiharu Yamazaki, Tokyo (JP); Tohru Sunaga, Osaka (JP)

Correspondence Address: HOGAN & HARTSON L.L.P., 1999 AVENUE OF THE STARS, SUITE 1400, LOS ANGELES, CA, 90067, US

(73) Assignee: Kyocera Corporation, Kyoto (JP)

(21) Appl. No.: 12/091,732

(22) PCT Filed: Oct. 26, 2006
(86) PCT No.: PCT/JP2006/321388

§ 371 Date: Aug. 14, 2009

(30) Foreign Application Priority Data
Oct. 28, 2005 (JP) 2005-315464

(51) Int. Cl. H01Q 3/00

(52) U.S. Cl. 342/377

(57) ABSTRACT

An adaptive away antenna apparatus having an array antenna which includes a plurality of antenna elements, wherein a received signal received by each of the antenna elements is weighted by a weighting factor, and then the received signals of the antenna elements are synthesized to be output as a synthesized signal. The apparatus includes a weighting-factor computing device for computing a weighting factor assigned to the received signal of each antenna element by using adaptive control; and an adaptive-control varying device for varying the adaptive control used by the weighting-factor computing device, in accordance with the number of times the computation is performed by the adaptive-control varying device with respect to the weighting factor. The adaptive-control varying device varies the adaptive control by decreasing the rate of update with respect to the weighting factor in accordance with the number of times the computation is performed.

### TECHNICAL FIELD

The present invention relates to an adaptive array antenna apparatus and an adaptive control method therefor.

Priority is claimed on Japanese Patent Application No. 2005-315464, filed Oct. 28, 2005, the content of which is incorporated heroin by reference.

### BACKGROUND ART

Generally, an adaptive array antenna apparatus has an array antenna including a plurality of antenna elements. The signals received by the antenna elements ore synthesized after they are subjected to weighting using weighting factors. As an adaptive algorithm for computing the weighting factors, LMS (least mean square) may be used. That is, in the adaptive array antenna apparatus, when both a desired wave, which has a correlation with the plurality of antenna elements, and another disturbing wave, which has a similar correlation, are received, control is performed in a manner such that the desired wave is amplified while the disturbing wave is cancelled.

With reference to FIG. 3, a conventional adaptive array antenna apparatus (called simply “the antenna apparatus” below) will be explained. The shown antenna apparatus 10 has an array antenna 11 having a plurality of antenna elements 11a and 11b (that is, two antenna elements are shown in FIG. 3), and also has multipliers 12a and 12b, an adder 13, an adaptive control part 14, and a storage part 15. A signal (explained later) output from the adder 13 is supplied to a reception processing part 16 which is provided in a wireless communication apparatus, so that the signal output from the adder 13 is subjected to demodulation and the like.

In the example shown in FIG. 3, although the signals received by the antenna elements 11a and 11b are respectively supplied to the multipliers 12a and 12b, another port such as a wireless part (not shown) is provide between the antenna elements 11a and 11b and the multipliers 12a and 12b. Such a wireless part amplifies the signals received from the antenna elements 11a and 11b, and converts them into baseband signals. The baseband signals are further converted by an A/D converter into digital signals SR1 and SR2 (called simply the “received signals” below), which are respectively supplied in the multipliers 12a, and 12b.

That is, the received signals SR1 and SR2 corresponding to the antenna elements 11a and 11b are respectively supplied to the multipliers 12a and 12b. The multipliers 12a and 12b respective multiply the received signals SR1 and SR2 by weighting factors W1 and W2 provided from the adaptive, control part 14, and output weighted received signals SW. The weighted received signals SW are supplied to the adder 13, and added to each other, thereby providing an added received signal SO (i.e., output signal). The output signal SO is supplied to the reception processing part 16, and also to the adaptive control part 14.

The adaptive control part 14 computes the weighting factors W1 and W2 for controlling the directivity of the array antenna consisting of the antenna elements 11a and 11b, by using an adaptive algorithm which may be LMS. The computed weighting factors W1 and W2 are respectively supplied to the multipliers 12a and 12b. As shown in FIG. 3, a reference signal Sref from the storage part 15, and the receive signals SR1 and SR2 are supplied to the adaptive control part 14. In the storage part 15, the reference signal Sref, which may correspond to a known pilot signal, is stored in advance.

The adaptive control part 14 performs adaptive control by means of LMS using the reference signal Sref, the received signals SR1 and SR2, and the output signal SO, so as to compute the weighting factors W1 and W2. The computation of the Weighting factors W1 and W2 by means of LMS is indicated as follows:

W(m+1)=W(m)+μX(m)e*(m) (1)

where W(m) indicates a weighting factor at a sampling number “m” which indicates the number of times the computation is performed with respect to the weighting factor (m is an integer greater than or equal to 1); μ indicates a step size (for controlling the rate of update with respect to the weighting factor); X(m) indicates the received signal at sampling number m; and e*(m) indicates the error (vector) between the received signal and the reference signal. Therefore, the above formula (1) is applied to an example for updating the weighting factor at each sampling of the received signal (see Nobuyoshi Kikuma, “ADAPTIVE SIGNAL PROCESSING with Array Antenna”, Science and Technology Publishing Company, Inc.).

Below, variations in The number of times (the number of iterations, that is, the above “m”) and the square error (|e(m)|²) with respect to the adaptive control (i.e., adaptive processing) performed in the adaptive control part 14 will be explained. FIG. 4 is a graph showing a variation in the square error at each iteration when performing the adaptive control by means of LMS, as shown in the above formula (1), in a situation in which the received signal includes a disturbing wave. In FIG. 4, the curve L1 indicates a variation in the square error when μ is 1, and the curve L2 indicates a variation in the square error when μ is 0.5.

As shown in FIG. 4, in both curves L1 and L2, the square error decreases when the number of iterations increases. When the number of iterations reaches a specific value, the square error becomes constant. This constant state indicates convergence of the adaptive control in which the disturbing wave (including a noise element) cannot be further cancelled even by continuing the weighting-factor computation, that is, the adaptive control.

A technique is known in which the weighting algorithm is adoptively updated in accordance with a variation in peripheral conditions, so as to improve the relevant convergence speed when an impulse response at an echo path in a loudspeaker communication system varies (see Patent Document 1: Japanese Unexamined Patent Application, First Publication No. 2002-135170).

In the conventional antenna apparatuses, when the step size μ is large, the adaptive control reaches convergence after a small number of iterations (see FIG. 4). On the other hand, the smaller the step size μ, the smaller the square error after the adaptive control reaches convergence. Generally, when the step size μ approaches “1”, the convergence occurs relatively rapidly. However, in this case, the value (i.e., square error) after the convergence is not stabilized (that is, a relatively large fluctuation occurs in the square error). In contrast, when the step size μ is decreased, the value (i.e., square error) after the convergence is relatively stabilised even though the convergence has been delayed.

However, in the conventional antenna, apparatuses, as the step size μ is fixed, a so-called “trade off” occurs between the speed of the convergence and the error after the convergence, and the number of iterations is restricted. Therefore, a sufficient advantage (affects) cannot be obtained even when performing the adaptive control.

### DISCLOSURE OF INVENTION

In light of the above circumstances, an object of the present invention is to provide an adaptive array antenna apparatus and an adaptive control method therefor, by which even when the number of iterations is restricted, a sufficient advantage of the adaptive control can be obtained.

In order to achieve the object, the present invention provides an adaptive array antenna apparatus having an array antenna which includes a plurality of antenna elements, wherein a received signal received by each of the antenna elements is weighted by a weighting factor, and then the received signals of the antenna elements are synthesized to be input as a synthesized signal, the apparatus comprises:
a weighting-factor computing device for computing a weighting factor assigned to the received signal of each antenna element by using adaptive control; and
an adaptive-control varying device for varying the adaptive, control used by the weighting-factor computing device, in accordance with the number of times the computation is performed by the adaptive-control varying device with respect to the weighting factor.

The above “computing a weighting factor assigned to the received signal . . . by using adaptive control” may practically mean to adaptively compute the weighting factor assigned to the received signal. In addition, the above “varying the adaptive control used by the weighting-factor computing device” may practically indicate computation of the weighting factor by the weighting-factor computing device.

Typically, the adaptive-control varying device varies the adaptive control by decreasing the rate of update with respect to the weighting factor in accordance With the number of times the computation is performed.

In a preferable example:
the weighting-factor computing device uses LMS as an adaptive algorithm;
the weighting-factor computing device provides the number of times the computation is performed to the adaptive-control varying device; and
the adaptive-control varying device varies the adaptive control by changing a step size for controlling the rate of update with respect to the weighting factor in the LMS, in accordance with the number of times the computation is performed.

In a typical example of this case:
until the number of times the computation is performed reaches a predetermined threshold, the adaptive-control varying device selects a value, as the step size, for rapidly converging the adaptive control; and
when the number of times the computation is performed reaches a predetermined threshold, the adaptive-control varying device selects a value, as the Step size, for stabilizing a square error with respect in the adaptive control.

The present invention also provides an adaptive control method used when a received signal received by each of antenna elements of an array antenna is weighted by a weighting factor, and then the received signals of the antenna elements are synthesized to be output as a synthesized signal, the method comprises:
a weighting-factor computing step of computing a weighting factor assigned to the received signal of each antenna element by using adaptive control; and
an adaptive-control varying step of varying the adaptive control used in the weighting factor computing step, in accordance with me number of times the computation is performed in the adaptive-control varying step with respect to the weighting factor.

Typically, in the adaptive control varying step, the adaptive control is varied by decreasing the rate of update with respect to the weighting factor in accordance with the number of times the computation is performed.

In a preferable example:
in the weighting-factor computing step, LMS is used as an adaptive algorithm; and
in the adaptive-control varying step, the adaptive control is varied by changing a step size for controlling the rate of update with respect to the weighting factor in the LMS, in accordance with the number of times the computation is performed.

In a typical example of this case, in the adaptive-control varying step:
until the number of times the computation is performed reaches a predetermined threshold, a value for rapidly converging the adaptive control is selected as the step size; and
when the number of times the computation is performed reaches a predetermined threshold, a value for stabilizing a square error with respect to the adaptive control is selected as the step size.

In accordance with the present invention, the adaptive control is varied in accordance with the number of times the computation is performed (i.e., the number of iterations). Therefore, even when the number of iterations is restricted, the adaptive control can be stably converged, and a sufficient advantage of the adaptive control can be obtained.

### BRIEF DESCRIPTION OF THE DRAWINGS

FIG. 1 is a block diagram showing an adaptive array antenna apparatus as an embodiment of the present invention.

FIG. 2 is a graph for explaining a relationship between the square error and the number of iterations when using the adaptive array antenna apparatus in FIG. 1.

FIG. 3 is a block diagram showing a conventional adaptive array antenna apparatus.

FIG. 4 is a graph for explaining relationships between the square error and the number of iterations when using the adaptive array antenna apparatus in FIG. 3.

### BEST MODE FOR CARRYING OUT THE INVENTION

Below, an embodiment in accordance with the present invention will be explained with reference to the drawings.

FIG. 1 is a block diagram showing an adaptive array antenna apparatus 20 as an embodiment of the present invention. In FIG. 1, identical structural elements to those of the adaptive, array antenna apparatus shown in FIG. 3 are given identical reference numerals or symbols. The shown adaptive array antenna, apparatus 20 (called simply the “antenna apparatus” below) includes the plurality of the antenna elements 11a and 11b, the multipliers 12a and 12b, the adder 13, and the storage part 15. The adaptive array antenna apparatus 20 also has an adaptive control part 21 (as the weighting-factor computing device) and a step size control part 22 (as the adaptive-control varying device).

Also in the example shown in FIG. 1, a part such as a wireless part (not shown) is provided between the antenna elements 11a and 11b and the multipliers 12a and 12b. Such a wireless part amplifies the signals received from the antenna elements 11a and 11b, and converts them into baseband signals. The baseband signals are further A/D-converted by an A/D converter, and the converted received signals SR1 and SR2 are respectively supplied to the multipliers 12a and 12b.

The adaptive control part 21 computes the weighting factors W1 and W2 for controlling the directivity of the array antenna consisting of the antenna elements 11a and 11b, by using an adaptive algorithm which may be LMS. The computed weighting factors W1 and W2 are respectively supplied to the multipliers 12a and 12b.

As shown in FIG. 1, the reference signal Sref from the storage part 15, and the received signals SR1 and SR2 are supplied to the adaptive control part 21. The adaptive control part 21 computes the weighting factors W1 and W2 by using the reference signal Sref, so as to increase the gain of desired signal elements included in the received signals SR1 and SR2.

When starting the adaptive control, the reference signal (e.g., pilot signal) included in each desired signal element is detected so as to start the adaptive control. Also when starting the adaptive control, the initial value of the step size μ is provided by the step-size control part 22, and based on the initial value, the adaptive control part 21 starts the adaptive control by means of LMS.

On the other hand, from an input device (not shown) or the like, the number of iterations for the relevant switching is provided as a threshold Th to the step-size control part 22, and a plurality of step sizes μ are also provided to the step-size control part 22 (in the shown example, two step sizes μ₁ and μ₂ are provided).

The adaptive control part 21 performs the adaptive control, and outputs the number C of iteration thereof to the step-size control part 22. When the number C of iteration supplied from the adaptive control part 21 reaches the threshold, the step-size control part 22 changes the step sizes μ, and die changed step sizes μ is provided to the adaptive control part 21. The adaptive control part 21 continues the adaptive control based on the changed step sizes μ.

When starting the adaptive control, a step size (e.g., μₜ=1) for increasing the convergence speed is supplied to the adaptive control part 21, and when the number C of iteration reaches the threshold Th, a step size (e.g., μ₂−0.5) for stabilizing the square error is supplied to the adaptive control part 21. That is, when the adaptive control is close to convergence, the step-size control part 22 provides a step size for stabilizing the square error to the adaptive control part 21.

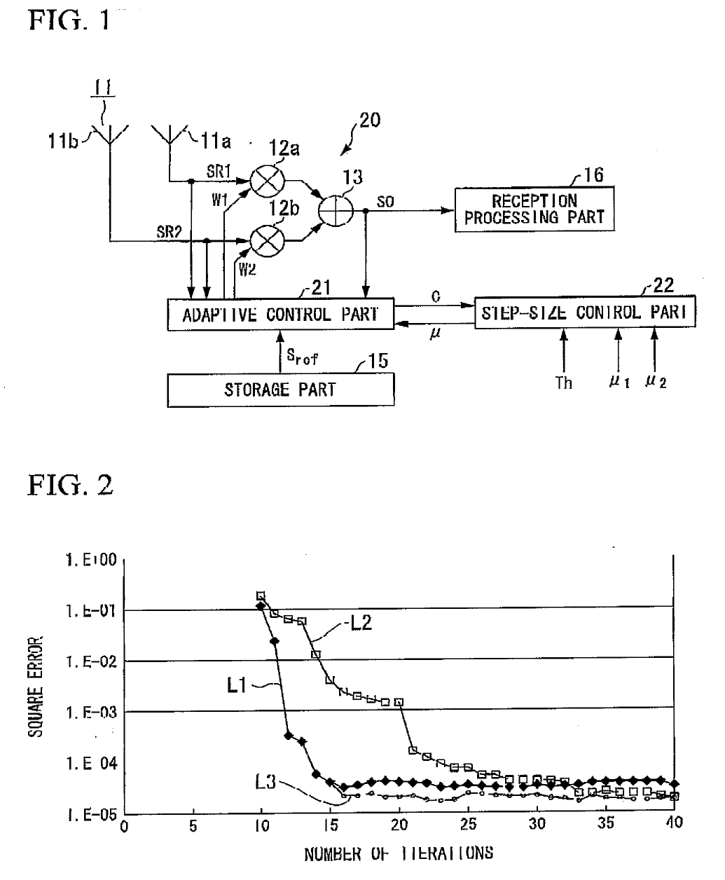

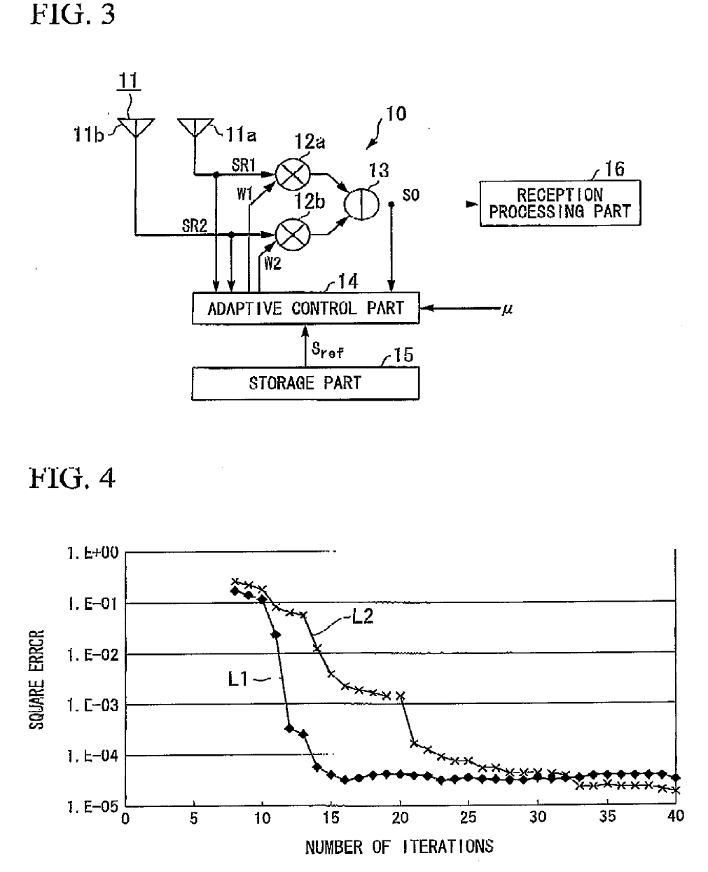

FIG. 2 is a graph showing a variation in the square error at each iteration when performing the adaptive control by means of LMS as shown in the above-described formula (1) in a situation in which the received signal includes a disturbing wave. In FIG. 2, the curve L1 indicates a variation in the square error when the step size is fixed to 1, and the curve L2 indicates a variation in the square error when the step size is fixed to 0.5. In addition, the curve L3 indicates a variation in the square error when the step size is changed in accordance with the number of iterations (in FIG. 2, the threshold Th=15, μ₁=1, and μ₂−0.5).

As shown by the curve L3 in FIG. 1, until the number C of iteration reaches 15, the step size is set as μ₁−1, so that the square error varies similar to the curve L1, and thus the convergence speed is high. When the number C of iteration roaches 15, the step size is set as μ₂=0.5 (that is, the step size is set as μ₂−0.5 when the number C of iteration is 16 or greater), so that the square error varies similar to the curve I2. Here, in the range in which the number C of iteration is 16 or greater, the curve L3 varies as if it inherited the curve L2 at the weighting factor W(m) by which the square error becomes 2×10⁻⁴ (i.e., 2·L−04) or smaller (in the shown example, the inheritance corresponds to the curve L2 when “m” (the number of iterations) is 33 or greater). Therefore, a stabilized low square error can be obtained by a smaller number of iterations in comparison with the curve C2.

As described above, the adaptive control is performed in a manner such that in accordance with the number of iterations, the step size is switched from one corresponding to a high convergence speed to one for providing a stabilized low square error. Therefore, a stabilized convergence state can be obtained relatively rapidly by using a simple structure.

The number of iterations for the relevant switching (i.e., the threshold Th) and the step sizes are appropriately determined in accordance with the format of the received signal, which is received by the relevant wireless communication apparatus, a wave transmission condition, usage, and peripheral conditions. When initializing the relevant wireless communication apparatus, the threshold Th and the step sizes are provided.

Also in the above embodiment, once the number of iterations for the relevant switching and the step sizes are set with respect to the wireless communication apparatus, it is unnecessary to change them in the processing. Therefore, resources of the wireless communication apparatus are not reduced by a process of changing the step size.

In addition, even with a smaller number of iterations, a weighting factor which is effective for suppressing a disturbing wave can be obtained only by changing the step size. Therefore, a sufficient advantage of the adaptive control can be obtained with a simple structure.

As described above, in accordance with the present embodiment, the adaptive control is varied in accordance with the number of iterations with respect to the weighting-factor computation. Therefore, oven when the number of iterations is restricted, the adaptive control can be stably converged, thereby providing a sufficient advantage of the adaptive control.

Furthermore, LMS is used as the adaptive algorithm for computing the weighting factor, and the step size for controlling the rate of update with respect to the weighting factor with respect to LMS is changed in accordance with the iteration. Therefore, before the number of iterations reaches the predetermined threshold, the step size for rapidly converging the adaptive control is selected, and when the number of iterations reaches the predetermined threshold, the step size for stabilizing the square error with respect to the adaptive control is selected. Therefore, the adaptive control can be stably converged by using a simple structure.

An embodiment of the present invention has been explained with reference to the drawings. However, concrete structures are not limited to the embodiment, and design modifications or the like can be made without departing from the scope of the present invention.

### INDUSTRIAL APPLICABILITY

In an adaptive array antenna apparatus, which includes a plurality of antenna, elements and in which a received signal received by each of the antenna elements is weighted by a weighting factor, and then the received signals are synthesized to be output as a synthesized signal, the adaptive control can be stably converged oven when the number of iterations is restricted.

1. An adaptive array antenna apparatus having an array antenna which includes a plurality of antenna elements, wherein a received signal received by each of the antenna elements is weighted by a weighting factor, and then the received signals of the antenna elements are synthesized to be output as a synthesized signal, the apparatus comprises:
a weighting-factor computing device for computing a weighting factor assigned to the received signal of each antenna element by using adaptive control; and
an adaptive-control varying device for varying the adaptive control used by the weighting-factor computing device, in accordance with the number of times the computation is performed by the adaptive-control varying device with respect to the weighting factor.

2. The adaptive array antenna apparatus in accordance with claim 1, wherein:
the adaptive-control varying device varies the adaptive control by decreasing the rate of update with respect to the weighing factor in accordance with the number of times the computation is performed.

3. The adaptive array antenna apparatus in accordance with claim 1, wherein:
the weighting-factor computing device uses LMS as an adaptive algorithm;
the weighting-factor computing device provides the number of times the computation is performed to the adaptive control varying device; and
the adaptive-control varying device varies the adaptive control by changing a step size for controlling the rate of update with respect to the weighting factor in the LMS, in accordance with the number of times the computation is performed.

4. The adaptive array antenna apparatus in accordance with claim 3, wherein:
until the number of times the computation is performed reaches a predetermined threshold, the adaptive-control varying device selects a value, as the step size, for rapidly converging the adaptive control; and
when the number of times the computation, is performed reaches a predetermined threshold, the adaptive-control varying device selects a value, as the step size, for stabilizing a square error with respect to the adaptive control.

5. An adaptive control method used, when a received signal received by each of antenna elements of an array antenna is weighted by a weighting factor, and then the received signals of the antenna elements are synthesized to be output as a synthesized signal, the method comprises:
a weighting-factor computing step of computing a weighting factor assigned to the received signal of each antenna element by using adaptive control; and
an adaptive-control varying step of varying the adaptive control used in the weighting-factor computing step, in accordance with the number of times the computation is performed in the adaptive-control varying step with respect to the weighting factor.

6. The adaptive control method in accordance with claim 5, wherein:
in the adaptive-control varying step, the adaptive control is varied by decreasing the rate of update with respect to the weighting factor in accordance with the number of times the computation is performed.

7. The adaptive control method in accordance with claim 5, wherein:
in the weighting-factor computing step, LMS is used as an adaptive algorithm; and
in the adaptive-control varying step, the adaptive control is varied by changing a step size for controlling the rate of update with respect to the weighting factor in the LMS, in accordance with the number of times the computation is performed.

8. The adaptive control method in accordance with claim 7, wherein in the adaptive-control varying step:
until the number of times the computation is performed reaches a predetermined threshold, a value for rapidly converging the adaptive control is selected as the step size; and
when the number of times the computation is performed reaches a predetermined threshold, a value for stabilizing a square error with respect to the adaptive control is selected as the step size.
